(19) United States
(12) Patent Application Publication
(10) Pub. No.: US 2023/0202508 A1
(43) Pub. Date: Jun. 29, 2023

(54) APPARATUS AND METHODS FOR PROVIDING AUDIO-BASED NAVIGATION

(71) Applicant: HERE GLOBAL B.V., Eindhoven (NL)

(72) Inventors: Leon Stenneth, Chicago, IL (US); Jerome Beaurepaire, Berlin (DE); Jeremy Michael Young, Chicago, IL (US)

(73) Assignee: HERE GLOBAL B.V., EINDHOVEN (NL)

(21) Appl. No.: 17/561,319

(22) Filed: Dec. 23, 2021

(51) Int. Cl. G01C 21/36

(52) U.S. Cl. CPC G01C 21/3629; G01C 21/3617; G01C 21/3661; G01C 21/3682

(57) ABSTRACT

An apparatus, method and computer program product are provided for providing audio-based navigation. In one example, the apparatus determines reliability of a navigation technique for a vehicle. If the navigation technique is unreliable, the apparatus causes the vehicle to rely on audio-based navigation to traverse a route. The audio-based navigation provides one or more navigational instructions based on a sound signature associated with a location.

### TECHNICAL FIELD

The present disclosure generally relates to the field of navigation, associated methods and apparatus, and in particular, concerns, for example, an apparatus configured to provide audio-based navigation for vehicles based on one or more sound signatures associated with one or more locations.

### BACKGROUND

Vehicles, drones, and/or other devices associated with mobility rely on navigation, such as a Global Positioning System (GPS), to reach destinations thereof. However, such system may be unreliable for navigating through certain landscapes (e.g., tunnels, canyons, cities, etc.) due to physical attributes thereof. Additionally, GPS reliant devices are susceptible to tampering and spoofing. Therefore, there is a need for an alternative navigation system or technique.

The listing or discussion of a prior-published document or any background in this specification should not necessarily be taken as an acknowledgement that the document or background is part of the state of the art or is common general knowledge.

### BRIEF SUMMARY

According to a first aspect, a non-transitory computer-readable storage medium having computer program code instructions stored therein is described. The computer program code instructions, when executed by at least one processor, cause the at least one processor to: determine reliability of a navigation technique for a vehicle; and responsive to the navigation technique being unreliable, cause the vehicle to rely on audio-based navigation to traverse a route, wherein the audio-based navigation provides one or more navigational instructions based on a sound signature associated with a location.

According to a second aspect, an apparatus comprising at least one processor and at least one non-transitory memory including computer program code instructions is described. The computer program code instructions, when executed, cause the apparatus to: determine a route of a vehicle; based on map data, identify one or more speakers within or proximate to the route; associate one or more navigational instructions for the route with one or more sound signatures; and assign the one or more sound signatures to be output at the respective one or more speakers.

According to a third aspect, a method of providing audio-based navigation is described. The method comprising: determining reliability of a navigation technique for a vehicle; and responsive to the navigation technique being unreliable: determining a route of a vehicle; based on map data, identifying one or more sound events within or proximate to the route, wherein the one or more sound events is defined by one or more periods and locations in which one or more sound signatures was previously recorded by one or more audio recorders; based on the route and one or more locations of the one or more sound events, associating one or more navigational instructions with the one or more sound signatures; and providing the one or more sound signatures to the vehicle.

Also, a computer program product may be provided. For example, a computer program product comprising instructions which, when the program is executed by a computer, cause the computer to carry out the steps described herein.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

The steps of any method disclosed herein do not have to be performed in the exact order disclosed, unless explicitly stated or understood by the skilled person.

Corresponding computer programs (which may or may not be recorded on a carrier) for implementing one or more of the methods disclosed herein are also within the present disclosure and encompassed by one or more of the described example embodiments.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

### BRIEF DESCRIPTION OF THE DRAWINGS

The embodiments of the invention are illustrated by way of example, and not by way of limitation, in the figures of the accompanying drawings:

FIG. 1 illustrates a diagram of a system capable of providing audio-based navigation;

FIG. 2 illustrates a diagram of the database within the system of FIG. 1;

FIG. 3 illustrates an example scenario in which an audio-based navigation platform and an audio-based navigation controller of FIG. 1 rely on sound generators of FIG. 1 for providing audio-based navigation;

FIG. 4 illustrates an example scenario in which the audio-based navigation platform and the audio-based navigation controller of FIG. 1 rely on sound events for providing audio-based navigation;

FIG. 5 illustrates a flowchart of a process for conditionally providing audio-based navigation;

FIG. 6 illustrates a flowchart of a process for providing audio-based navigation based on one or more sound signatures output by one or more sound generators;

FIG. 7 illustrates a flowchart of a process for providing audio-based navigation based on one or more sound events;

FIG. 8 illustrates a computer system upon which an embodiment may be implemented;

FIG. 9 illustrates a chip set or chip upon which an embodiment may be implemented; and

FIG. 10 illustrates a diagram of exemplary components of a mobile terminal for communications, which is capable of operating in the system of FIG. 1.

### DETAILED DESCRIPTION

Vehicles rely on GPS to navigate a route to a destination. Autonomous vehicles (i.e., self-driving vehicles) rely at least in part on GPS to traverse a route without requiring human inputs for maneuvering the vehicles. GPS reliant devices are also critical components for logistics monitoring, disaster responses, traffic monitoring, and host other civil and military applications. While GPS is commonly relied upon for various applications, such system can be rendered unreliable in locations that adversely impact signals transmitted from satellites to the GPS reliant devices. Specifically, accuracy of position estimate for a GPS reliant device improves as a number of signals that the device receives from satellites increase. Since each satellite is broadcasting a signal that covers a substantial portion of Earth’s surface, the signals transmitted by the satellites are fragile and are therefore extremely vulnerable to blockage from physical objects, such as buildings, terrains, tunnels, canyons, etc. Additionally, GPS tampering and spoofing can adversely impact applications of GPS reliant devices. Therefore, there is a need in the art for an alternative navigation method.

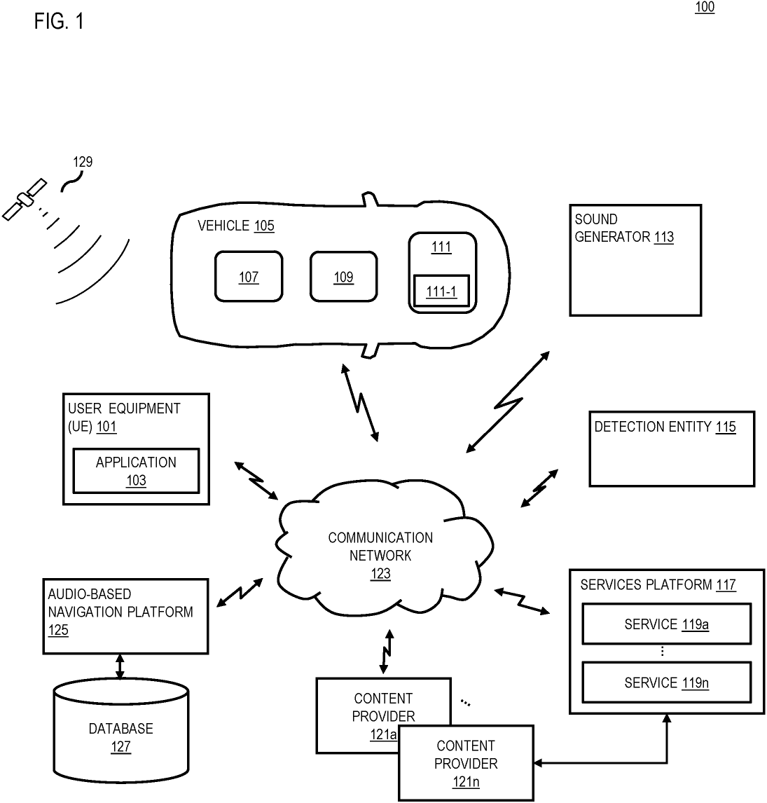

FIG. 1 is a diagram of a system 100 capable of providing audio-based navigation, according to one embodiment. The system includes a user equipment (UE) 101, a vehicle 105, a sound generator 113, a detection entity 115, a services platform 117, content providers 121a-121n, a communication network 123, an audio-based navigation platform 125, a database 127, and a satellite 129. Additional or a plurality of mentioned components may be provided.

In the illustrated embodiment, the system 100 comprises a user equipment (UE) 101 that may include or be associated with an application 103. In one embodiment, the UE 101 has connectivity to the audio-based navigation platform 125 via the communication network 123. The audio-based navigation platform 125 performs one or more functions associated with providing audio-based navigation. In the illustrated embodiment, the UE 101 may be any type of mobile terminal or fixed terminal such as a mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, devices associated with or integrated with one or more vehicles (including the vehicle 105), or any combination thereof, including the accessories and peripherals of these devices. In one embodiment, the UE 101 can be an in-vehicle navigation system, a personal navigation device (PND), a portable navigation device, a cellular telephone, a mobile phone, a personal digital assistant (PDA), a watch, a camera, a computer, and/or other device that can perform navigation-related functions, such as digital routing and map display. In one embodiment, the UE 101 can be a cellular telephone. A user may use the UE 101 for navigation functions, for example, road link map updates. It should be appreciated that the UE 101 can support any type of interface to the user (such as “wearable” devices, etc.). In one embodiment, the one or more vehicles may have cellular or Wi-Fi connection either through the inbuilt communication equipment or from the UE 101 associated with the vehicles. The application 103 may assist in conveying and/or receiving information regarding audio-based navigation.

In the illustrated embodiment, the application 103 may be any type of application that is executable by the UE 101, such as a mapping application, a location-based service application, a navigation application, a content provisioning service, a camera/imaging application, a media player application, a social networking application, a calendar application, or any combination thereof. In one embodiment, one of the applications 103 at the UE 101 may act as a client for the audio-based navigation platform 125 and perform one or more functions associated with the functions of the audio-based navigation platform 125 by interacting with the audio-based navigation platform 125 over the communication network 123. The application 103 may provide information associated with navigational instructions, sound signatures associated with navigational instructions, locations in which audio-based navigation is available, etc.

The vehicle 105 may be a standard gasoline powered vehicle, a hybrid vehicle, an electric vehicle, a fuel cell vehicle, and/or any other mobility implement type of vehicle. The vehicle 105 includes parts related to mobility, such as a powertrain with an engine, a transmission, a suspension, a driveshaft, and/or wheels, etc. The vehicle 105 may be a non-autonomous vehicle or an autonomous vehicle. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one embodiment, the vehicle 105 may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle 105, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

In one embodiment, the UE 101 may be integrated in the vehicle 105, which may include assisted driving vehicles such as autonomous vehicles, highly assisted driving (HAD), and advanced driving assistance systems (ADAS). Any of these assisted driving systems may be incorporated into the UE 101. Alternatively, an assisted driving device may be included in the vehicle 105. The assisted driving device may include memory, a processor, and systems to communicate with the UE 101. In one embodiment, the vehicle 105 may be an HAD vehicle or an ADAS vehicle. An HAD vehicle may refer to a vehicle that does not completely replace the human operator. Instead, in a highly assisted driving mode, a vehicle may perform some driving functions and the human operator may perform some driving functions. Such vehicle may also be driven in a manual mode in which the human operator exercises a degree of control over the movement of the vehicle. The vehicle 105 may also include a completely driverless mode. The HAD vehicle may control the vehicle through steering or braking in response to the on the position of the vehicle and may respond to lane marking indicators (lane marking type, lane marking intensity, lane marking color, lane marking offset, lane marking width, or other characteristics) and driving commands or navigation commands. Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) and driving commands or navigation commands.

In this illustrated example, the vehicle 105 includes a plurality of sensors 107, an on-board communication platform 109, and an on-board computing platform 111. The sensors 107 include an audio recorder for gathering audio data (not illustrated) for recording sound generated from outside the vehicle 105. One or more audio recorders may be mounted on an exterior surface of the vehicle 105. The sensors 107 also include a global positioning sensor (not illustrated) for gathering location data associated with the vehicle 105. In one embodiment, the vehicle 105 may include GPS receivers to obtain geographic coordinates from satellites 129 for determining current location and time associated with the vehicle 105. Further, the location can be determined by a triangulation system such as A-GPS, Cell of Origin, or other location extrapolation technologies. The sensors 107 may include other sensors such as image sensors (e.g., electronic imaging devices of both analog and digital types, which include digital cameras, camera modules, camera phones, thermal imaging devices, radar, sonar, lidar, etc.), a network detection sensor for detecting wireless signals or receivers for different short-range communications (e.g., Bluetooth, Wi-Fi, Li-Fi, near field communication (NFC), etc.), temporal information sensors, velocity sensors, light sensors, oriental sensors augmented with height sensor and acceleration sensor, tilt sensors to detect the degree of incline or decline of the vehicle 105 along a path of travel, tire pressure sensors, temperature sensors, etc. In a further embodiment, sensors about the perimeter of the vehicle 105 may detect the relative distance of the vehicle 105 from road objects (e.g., road markings), lanes, or roadways, the presence of other vehicles, pedestrians, traffic lights, road objects, road features (e.g., curves) and any other objects, or a combination thereof.

The on-board communications platform 111 includes wired or wireless network interfaces to enable communication with external networks. The on-board communications platform 111 also includes hardware (e.g., processors, memory, storage, antenna, etc.) and software to control the wired or wireless network interfaces. In the illustrated example, the on-board communications platform 109 includes one or more communication controllers (not illustrated) for standards-based networks (e.g., Global System for Mobile Communications (GSM), Universal Mobile Telecommunications System (UMTS), Long Term Evolution (LTE) networks, 5G networks, Code Division Multiple Access (CDMA), WiMAX (IEEE 802.16 m); Near Field Communication (NFC); local area wireless network (including IEEE 802.11 a/b/g/n/ac or others), dedicated short range communication (DSRC), and Wireless Gigabit (IEEE 802.11 ad), etc.). In some examples, the on-board communications platform 109 includes a wired or wireless interface (e.g., an auxiliary port, a Universal Serial Bus (USB) port, a Bluetooth® wireless node, etc.) to communicatively couple with the UE 101.

The on-board computing platform 111 performs one or more functions associated with the vehicle 105. In one embodiment, the on-board computing platform 109 may aggregate sensor data generated by at least one of the sensors 107 and transmit the sensor data via the on-board communications platform 109. The on-board computing platform 109 may receive control signals for performing one or more of the functions from the audio-based navigation platform 125, the UE 101, the services platform 117, one or more of the content providers 121a-121n, or a combination thereof via the on-board communication platform 111. The on-board computing platform 111 includes at least one processor or controller and memory (not illustrated). The processor or controller may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

The on-board computing platform 111 may embody an audio-based navigation controller 111-1 for performing one or more functions associated with audio-based navigation. In one embodiment, the audio-based navigation controller 111-1 may be stored in the memory as computer program code and may be executable by the processor of the on-board computing platform 111 to cause the processor to interact with various components of the vehicle 105. In one embodiment, one or more hardware and software components within the on-board computing platform 111 may define the audio-based navigation controller 111-1. In one embodiment, the audio-based navigation controller 111-1 may be a software that may be downloaded from the audio-based navigation platform 125. Details of the audio-based navigation controller 111-1 will be further described in conjunction with the audio-based navigation platform 125.

The sound generator 113 may be a stationary speaker disposed within a road network. In one embodiment, the sound generator 113 includes an electroacoustic transducer (not illustrated), a power supply (not illustrated), a transmitter (not illustrated), and a receiver (not illustrated). The sound generator 113 is capable of receiving instructions for generating sound at a range of amplitude/frequency. In such embodiment, the sound generator 113 may receive the instructions from the audio-based navigation platform 125. In one embodiment, the sound generator 113 may generate sound based on audio data stored therein and continuously output the sound in a loop. In one embodiment, the sound generator 113 may transmit, to the audio-based navigation platform 125: (1) sound that the sound generator 113 is currently generating; (2) audio data stored in the sound generator 113 that can be output as sound; (3) one or more attributes (e.g., amplitude, frequency, etc.) of each audio data that can output as sound; or (4) a combination thereof. In one embodiment, the sound generator 113 may generate sound at a frequency that is outside a human hearable frequency range. In one embodiment, one or more sound generators 113 may be disposed within or proximate to one or more road segments, links, and/or nodes. In one embodiment, one or more sound generators 113 may disposed in urban locations, tunnels, underground locations, etc. It is contemplated that sound generators 113 may be installed in or proximate to road locations where navigation techniques, such GPS, are historically known to be unreliable.

The detection entity 115 may be another vehicle, a drone, a user equipment, a road-side sensor, or a device mounted on a stationary object within or proximate to a road segment (e.g., a traffic light post, a sign post, a post, a building, etc.). The detection entity 115 includes one or more audio recorders (not illustrated) for gathering audio data. The detection entity 115 may include other sensors such as velocity sensors, oriental sensors augmented with height sensor and acceleration sensor, tilt sensors, etc. Using such sensors, the detection entity 115 may determine a direction at which the one or more audio recorders captures audio data. In one embodiment, the detection entity 115 may store information indicating orientation and position at which the one or more audio recorders are mounted on a body of the detection entity 115. Stationary detection entities 115 may store information indicating a location at which said entities are disposed. Non-stationary detection entities 115 may utilize GPS, localization, a triangulation system such as A-GPS, Cell of Origin, or other location extrapolation technologies to determine locations thereof and store the location information. For detection entities 115 that are vehicles, such vehicles may include sensors for recording vehicle movement data (e.g., an angle at which wheels are turned at a given time frame, velocity of the vehicle at a given time frame, acceleration of the vehicle at a given time frame, etc.). Such vehicles may be also equipped with image sensors for recording images corresponding to the vehicle movement data (e.g., cameras recording images of path of travel that correspond to the vehicle movement data). The detection entity 115 may transmit one or more of the aforementioned information stored therein to the audio-based navigation platform 125.

The services platform 117 may provide one or more services 119a-119n (collectively referred to as services 119), such as mapping services, navigation services, travel planning services, weather-based services, emergency-based services, notification services, social networking services, content (e.g., audio, video, images, etc.) provisioning services, application services, storage services, contextual information determination services, location-based services, information-based services, etc. In one embodiment, the services platform 117 may be an original equipment manufacturer (OEM) platform. In one embodiment the one or more service 119 may be sensor data collection services. By way of example, vehicle sensor data provided by the sensors 107 may be transferred to the UE 101, the audio-based navigation platform 125, the database 127, or other entities communicatively coupled to the communication network 123 through the service platform 115. In one embodiment, the services platform 117 uses the output data generated by of the audio-based navigation platform 125 to provide services such as navigation, mapping, other location-based services, etc.

In one embodiment, the content providers 121a-121n (collectively referred to as content providers 121) may provide content or data (e.g., including geographic data, parametric representations of mapped features, etc.) to the UE 101, the vehicle 105, services platform 117, the vehicle 105, the database 127, the audio-based navigation platform 125, or the combination thereof. In one embodiment, the content provided may be any type of content, such as map content, textual content, audio content, video content, image content, etc. In one embodiment, the content providers 121 may provide content that may aid in providing audio-based navigation, and/or other related characteristics. In one embodiment, the content providers 121 may also store content associated with the UE 101, the vehicle 105, services platform 117, the vehicle 105, the database 127, the audio-based navigation platform 125, or the combination thereof. In another embodiment, the content providers 121 may manage access to a central repository of data, and offer a consistent, standard interface to data, such as a repository of the database 127.

The communication network 123 of system 100 includes one or more networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In the illustrated embodiment, the audio-based navigation platform 125 may be a platform with multiple interconnected components. The audio-based navigation platform 125 may include multiple servers, intelligent networking devices, computing devices, components and corresponding software for providing audio-based navigation. It should be appreciated that that the audio-based navigation platform 125 may be a separate entity of the system 100, included within the UE 101 (e.g., as part of the applications 103), included within the services platform 117 (e.g., as part of an application stored in server memory for the services platform 117), included within the content providers 121 (e.g., as part of an application stored in sever memory for the content providers 121), other platforms embodying a power supplier (not illustrated), or a combination thereof.

The audio-based navigation platform 125 and the audio-based navigation controller 111-1 work in conjunction to provide audio-based navigation for the vehicle 105. In one embodiment, the audio-based navigation platform 125: (1) acquires a route of the vehicle 105; (2) determines one or more locations of one or more sound generators 113 that is within or proximate to the route of the vehicle 105; (3) for each sound generator 113, assigns a sound signature and a navigational instruction for the vehicle 105; (4) transmits the one or more sound signatures and the one or more navigational instructions to the vehicle 105; and (5) causes the one or more sounds generators to generate the one or more sound signatures. The audio-based navigation controller 111-1: (1) receives the one or more sound signatures and the one or more navigational instructions; (2) as the vehicle 105 is traversing the route, uses one or more audio recorders of the vehicle 105 to determine whether one of the one or more sound signatures is being detected via one or more audio recorders of the vehicle 105; and (3) when said sound signature is detected, causes the UE 101 and/or a user interface associated with the vehicle 105 to present a navigational instruction corresponding to said sound signature or causes the vehicle 105 to move based on the navigational instruction. Herein, a sound signature is defined in a form audio data or sound output via a speaker as a function of audio data. In one embodiment, a sound signature output at each sound generator 113 may be unique. In one embodiment, a sound signature may be selectively identifiable by one or more vehicles. In such embodiment, the audio-based navigation platform 125 provides the sound signature to said vehicles, and only said vehicles may be able to identify the sound signature via audio recorders thereof. In one embodiment, the sound signature may be outside a human hearing range and be discernible to one or more audio records of the vehicle 105. In one embodiment, a navigational instruction associated with a sound signature indicates an instruction for steering the vehicle 105 to a certain direction to a certain degree, an instruction for altering the speed of the vehicle to a certain level, or a combination thereof. In one embodiment, the audio-based navigation platform 125 may compile sound signatures and navigational instructions associated therewith as a list, and the order at which the list is complied may reflect an order at which the vehicle 105 is expected to encounter the sound generators 113 as the vehicle 105 traverses the route. In one embodiment, the audio-based navigation controller 111-1 may determine a position of the vehicle 105 based on attributes of audio data as recorded by one or more audio recorders of the vehicle 105 as the vehicle 105 traverses a location in which a stationary sound generator 113 is outputting a sound signature. In such embodiment, the audio-based navigation controller 111-1 may cause the vehicle 105 to move based on one or more navigational instructions if attributes of sound signature as captured by one or more audio recorders of the vehicle 105 reaches one or more specific values. For example, a change in frequency/amplitude of audio data as captured by the vehicle 105 may correlate to a change in position of the vehicle 105. If the frequency/amplitude of the sound signature captured by one or more audio recorders of the vehicle 105 reaches a predetermined level, the audio-based navigation controller 111-1 may cause the vehicle 105 to move based on one or more navigational instructions as received from the audio-based navigation platform 125. In one embodiment, the audio-based navigation controller 111-1 may determine a position of the vehicle 105 based on a speed of the vehicle 105 as the vehicle 105 traverses a portion of a route having a stationary sound generator 113 disposed therein. As the sound generator 113 generates a sound signature, the audio-based navigation controller 111-1 uses the Doppler effect of the sound output from the sound generator 113. The audio-based navigation controller 111-1 may calculate a pitch shift based on the speed of the vehicle 105 as the vehicle 105 moves towards the sound generator 113. Based on the pitch shift, the audio-based navigation controller 111-1 may estimate a position of the vehicle 105. The audio-based navigation platform 125 may assign a navigational instruction for a pitch shift and provide the navigation instruction to the audio-based navigation controller 111-1 prior to the vehicle 105 approaching the sound generator 113.

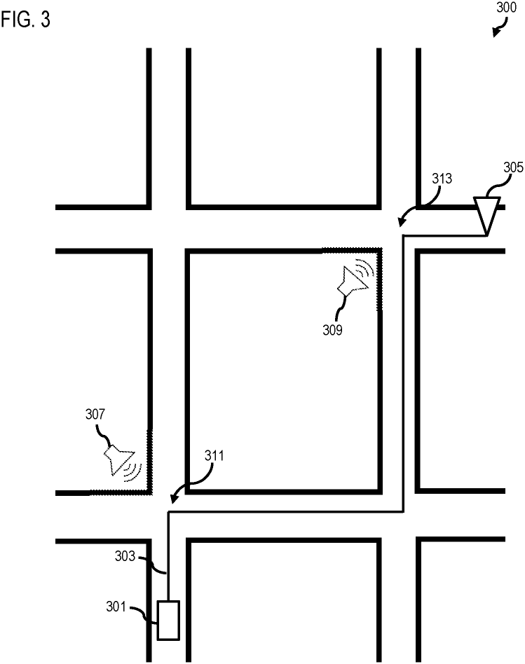

FIG. 3 illustrates an example scenario 300 in which the audio-based navigation platform 125 and the audio-based navigation controller 111-1 rely on sound generators 113 for providing audio-based navigation. In the illustrated embodiment, a vehicle 301 is requesting an audio-based navigation for a route 303 to a destination 305. In response, the audio-based navigation platform 125 identifies one or more sound generators 113 that is associated with the route 303. In the illustrated embodiment, the audio-based navigation platform 125 determines that a first sound generator 307 and a second sound generator 309 are proximate to the route 303. As such, the audio-based navigation platform 125 assigns the first sound generator 307 to output a first sound signature and the second generator 309 to output a second sound signature. Further, the audio-based navigation platform 125 determines a first navigational instruction associated with the first sound signature (i.e., instructing the vehicle 301 to turn right at a first intersection 311 proximate to the first sound generator 307) and a second navigational instruction associated with the second sound signature (i.e., instructing the vehicle 301 to turn right at a second intersection 313 proximate to the second sound generator 309) and transmits the first and second sound signatures and the first and second navigational instructions to the vehicle 301. In the illustrated embodiment, the vehicle 301 is assumed to exemplify the vehicle 105 and includes the audio-based navigation controller 111-1. The audio-based navigation controller 111-1 of the vehicle 301 receives the first and second sound signatures and the first and second navigational instructions. As the vehicle 301 approaches the first sound generator 307, the vehicle 301 uses the audio recorders thereof to determine whether the first sound signature is being output by the first sound generator 307. If the audio-based navigation controller 111-1 acquires the first sound signature via the audio recorders, the audio-based navigation controller 111-1 notifies the vehicle 301 that the vehicle 301 is approaching the first intersection 311 and that the vehicle 301 should make a right turn at the first intersection 311. In one embodiment, the audio-based navigation controller 111-1 relies on attributes of the first sound signature as captured via the audio recorders to determine relative distance of the vehicle 301 to the first intersection 311. For example, an increasing level of amplitude of the first sound signature may be correlated with decreasing distance between the vehicle 301 and the first intersection 311. In one embodiment, the first navigational instruction may indicate that the vehicle 301 should make a right turn as soon as the audio recorders of the vehicle 301 captures one or more specific values associated with one or more attributes of the first sound signature (e.g., one or more values of amplitudes, frequency, etc.). In an alternative embodiment, the first navigational instruction may be simple instruction that the vehicle 301 should expect to make a right turn soon and that the vehicle 301 should rely on specific sensors, such as lidar, to navigate the first intersection once the vehicle 301 acquires the first sound signature via the audio recorders thereof. As the vehicle 301 approaches the second sound generator 309, the vehicle 301 uses the audio recorders thereof to determine whether the second sound signature is being output by the second sound generator 309. If the audio-based navigation controller 111-1 acquires the second sound signature via the audio recorders, the audio-based navigation controller 111-1 may perform similar features as discussed above.

In one embodiment, the audio-based navigation platform 125 does not rely on sound generators 113 for providing audio-based navigation; rather, the audio-based navigation platform 125 maintains an audio-based map including one or more sound events, where each sound event is updated based on historical data of audio data captured at various locations and periods. In such embodiment, one or more detection entities 115 captures audio data and provides, to the audio-based navigation platform 125, the audio data and contextual data indicating a location and period in which such audio data was captured. The audio-based navigation platform 125 classifies the audio data as a category and stores the audio data as a sound signature. Further, the audio-based navigation platform 125 create a sound event in the audio-based map to indicate that the sound signature was captured at a given location at a given period. In one embodiment, a sound event may be associated with a confidence level indicating a confidence at which the sound event is likely to happen at one or more future periods. In such embodiment, if the audio-based navigation platform 125 continuously receives audio data and contextual data associated therewith that validate the same sound signature being captured at the same location and period, the confidence associated with the sound event increases; whereas, if the audio-based navigation platform 125 does not receive audio data and contextual data associated therewith at the location and period, the audio-based navigation platform 125 gradually decreases the confidence level. In one embodiment, the audio-based navigation platform 125 only relies on sound events whose confidence levels exceed a threshold level, thereby ensuring that an audio-based navigation provided as a function of sound events outputs a reliable in-vehicle navigation. Once the audio-based map is established with a plurality of sound events, the audio-based navigation platform 125: (1) acquires a route of the vehicle 105; (2) identifies one or more sound events that is within or proximate to the route of the vehicle 105; (3) for each sound event, identify the sound signature associated therewith and assign a navigational instruction for the vehicle 105; and (4) transmits one or more sound signatures associated with one or more sound events and one or more navigational instructions to the vehicle 105. The audio-based navigation controller 111-1: (1) receives the one or more sound signatures and the one or more navigational instructions; (2) as the vehicle 105 is traversing the route, uses one or more audio recorders of the vehicle 105 to determine whether one of the one or more sound signatures is being generated; and (3) when said sound signature is detected, causes the UE 101 and/or a user interface associated with the vehicle 105 to present a navigational instruction corresponding to said sound signature or causes the vehicle 105 to move based on the navigational instruction.

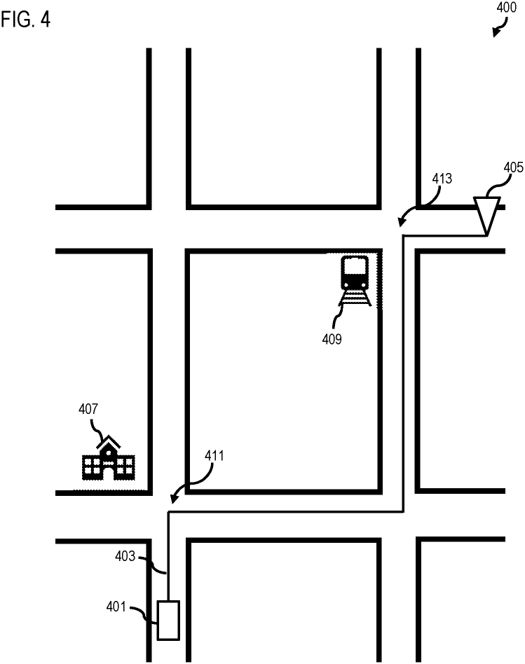

FIG. 4 illustrates an example scenario 400 in which the audio-based navigation platform 125 and the audio-based navigation controller 111-1 rely on sound events for providing audio-based navigation. In the illustrated embodiment, a vehicle 401 is requesting an audio-based navigation for a route 403 to a destination 405. In response, the audio-based navigation platform 125 uses an audio-based map to identify one or more sound events. In the illustrated embodiment, the audio-based navigation platform 125 determines that the vehicle 401 is estimated to arrive at the first intersection 411 at noon and at the second intersection 413 at 12:05PM. Further, using the audio-based map, the audio-based navigation platform 125 determines that a school 407 frequently generates a bell sound (i.e., a first sound signature) at noon to notify a start of recess period and a train station 409 frequently generates sound associated with an arrival of a train (i.e., a second sound signature) at 12:05PM. In the illustrated embodiment, the vehicle 401 is assumed to exemplify the vehicle 105 and includes the audio-based navigation controller 111-1. The audio-based navigation platform 125 determines a first navigational instruction associated with the first sound signature (i.e., instructing the vehicle 401 to turn right at a first intersection 411 proximate to the school 407) and a second navigational instruction associated with the second sound signature (i.e., instructing the vehicle 401 to turn right at a second intersection 413 proximate to the train station 409) and transmits the first and second sound signatures and the first and second navigational instructions to the vehicle 401. In the illustrated embodiment, the vehicle 401 is assumed to exemplify the vehicle 105 and includes the audio-based navigation controller 111-1. When the audio recorders of the vehicle 401 captures the first sound signature, the audio-based navigation controller 111-1 estimates a relative distance between the vehicle 401 and the intersection 411 based on attributes of the first sound signature as captured by the audio recorders. When a certain frequency/amplitude of the first sound signature is captured by the audio recorders, the audio-based navigation controller 111-1 causes a notification that the vehicle 401 should make a right turn and/or causes the vehicle 401 to make a right turn. When the audio recorders of the vehicle 401 captures the second sound signature, the audio-based navigation controller 111-1 estimates a relative distance between the vehicle 401 and the intersection 413 based on attributes of the second sound signature as captured by the audio recorders. When a certain frequency/amplitude of the second sound signature is captured by the audio recorders, the audio-based navigation controller 111-1 causes a notification that the vehicle 401 should make a right turn and/or causes the vehicle 401 to make a right turn.

In one embodiment, the audio-based navigation platform 125 acquires audio data and vehicle movement data from vehicles operating as detection entities 115 and uses the audio data and the vehicle movement data for providing audio-based navigation. Specifically, the audio-based navigation platform 125 acquires such data at locations in which sound signatures are output by sound generators 113. Herein, audio data captured by a detection entity 115 in a location and period in which a sound signature was output by a sound generator 113 will be referred as a recorded sound signature. When the vehicle 105 requests audio-based navigation and a route of the vehicle 105 includes or is proximate to a sound generator 113, the audio-based navigation platform 125 determines whether a detection entity 115 has previously traversed a portion of the route that includes or is proximate to the sound generator 113 based on vehicle movement data of the detection entity 115. If a detection entity 115 has previously traversed the portion of the route, the audio-based navigation platform 125 acquires a recorded sound signature associated with the portion of the route and transmits the recorded sound signature to the vehicle 105. The audio-based navigation controller 111-1 receives the recorded sound signature and determines whether the recorded sound signatures is being detected by the audio recorders of the vehicle 105 as the vehicle 105 is traversing the route. When said recorded sound signature is detected, the audio-based navigation controller 111-1 causes the vehicle 105 to move such that attributes of audio data captured by the audio recorders match attributes of the recorded sound signature. In one embodiment, in addition to transmitting the recorded sound signature, the audio-based navigation platform 125 transmits, to the audio-based navigation controller 111-1, the vehicle movement data of the detection entity 115. In such embodiment, if the audio-based navigation controller 111-1 detects the recorded sound signature, the audio-based navigation controller 111-1 causes the vehicle 105 to move based on the vehicle movement data. In one embodiment, the audio-based navigation platform 125 may rely on a recorded sound signature and vehicle movement data only if vehicle attributes of the vehicle 105 and a detection entity 115 associated with the recorded sound signature and the vehicle movement data are compatible. For example, compatibility between the vehicle 105 and the detection entity 115 may be defined by a type of vehicle, a number of audio recorders installed on the vehicle 105 or the detection entity 115, position/orientation of the audio recorders, type of audio recorders, or a combination thereof.

In one embodiment, the audio-based navigation platform 125 allows the vehicle 105 to rely on audio-based navigation when a non-audio-based navigation technique relied upon by the vehicle 105 becomes unreliable. For example, if the navigation technique is associated with GPS, and Circular Error Radius (CER) exceeds a threshold (e.g., 100 meters), the audio-based navigation platform 125 allows the vehicle 105 to rely on audio-based navigation. In one embodiment, the audio-based navigation platform 125 maps one or more locations and periods in which a non-audio-based navigation technique relied upon by one or more vehicles has been rendered unreliable. Using the map of the one or more locations, the audio-based navigation 125 may estimate whether the vehicle 105 is approaching one of the one or more locations and allow the vehicle 105 to rely on audio-based navigation if the vehicle 105 is estimated to approach said location. The aforementioned features may be performed by the audio-based navigation controller 111-1 or a combination of the audio-based navigation controller 111-1 and the audio-based navigation 125.

As discussed above, the audio-based navigation platform 125 may control sound output by sound generators 113. In one embodiment, the audio-based navigation platform 125 may further control a timing at which a sound generator 113 is controlled to generate sound. In one embodiment, the audio-based navigation platform 125 may cause a sound generator 113 to output a sound signature when the vehicle 105 is within a predetermined distance from the sound generator 113. The measurement of such distance may be rendered via GPS, lidar, and/or other distance measuring features available within the vehicle 105. Alternatively, one or more stationary sensors may be disposed in areas proximate to a sound generator 113, and the audio-based navigation platform 125 may determine a relative distance between the vehicle 105 and the sound generator 113 by using said sensors. In one embodiment, the audio-based navigation platform 125 causes a sound generator 113 to automatically output sound when a non-audio-based navigation technique relied upon by the vehicle 105 becomes unreliable.

In one embodiment, a sound generator 113 may be owned by an entity, and the entity may provide, to the audio-based navigation platform 125, information indicating one or more vehicles that is permitted to use the sound generator 113 for audio-based navigation. In such embodiment, the information may further indicate one or more periods in which the one or more vehicles can use the sound generator 113 for audio-based navigation. For one or more vehicles that is permitted by the entity to use the sound generator 113, the audio-based navigation platform 125 assigns a unique sound signature that can only be recognized by the one or more vehicles and used by the one or more vehicles for audio-based navigation.

It is contemplated that a sound signature output at a location can be replicated, thereby rendering audio-based navigation unreliable for said location. As such, in one embodiment, the audio-based navigation platform 125 provides audio-based navigation for the vehicle 105 based on a plurality of sound signatures that can simultaneously be output at a given location. In such embodiment, the audio-based navigation platform 125 determines whether: (1) one or more sound generators 113 are available within a location; (2) one or more sound events is predicted to occur at the location; or (3) a combination thereof. If the audio-based navigation platform 125 determines that a plurality of sources can simultaneously output a plurality of sound signatures at a location, the audio-based navigation platform 125 associates a navigational instruction for the location.

In the illustrated embodiment, the database 127 stores information on locations of sound generators 113, sound events, sound signatures, vehicle movement data, etc. The database 127 may also store information on road links (e.g., road length, road breadth, slope information, curvature information, geographic attributes, etc.), probe data for one or more road links (e.g., traffic density information), POIs, and other types map-related features. In one embodiment, the database 127 may include any multiple types of information that can provide means for aiding in providing audio-based navigation. It should be appreciated that the information stored in the database 127 may be acquired from any of the elements within the system 100, other vehicles, sensors, database, or a combination thereof.

In one embodiment, the UE 101, the vehicle 105, the sound generator 113, the detection entity 115, the services platform 117, the content providers 121, the audio-based navigation platform 125 communicate with each other and other components of the communication network 123 using well known, new or still developing protocols. In this context, a protocol includes a set of rules defining how the network nodes within the communication network 123 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

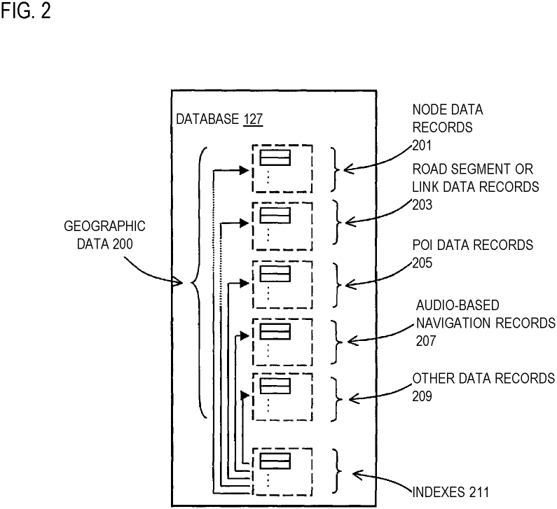

FIG. 2 is a diagram of a database 127 (e.g., a map database), according to one embodiment. In one embodiment, the database 127 includes data 200 used for (or configured to be compiled to be used for) mapping and/or navigation-related services, such as for personalized route determination, according to exemplary embodiments.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions, models, routes, etc. Accordingly, the terms polygons and polygon extrusions/models as used herein can be used interchangeably.

In one embodiment, the following terminology applies to the representation of geographic features in the database 127.

“Node” - A point that terminates a link.

“Line segment” - A straight line connecting two points.

“Link” (or “edge”) - A contiguous, non-branching string of one or more line segments terminating in a node at each end.

“Shape point” - A point along a link between two nodes (e.g., used to alter a shape of the link without defining new nodes).

“Oriented link” - A link that has a starting node (referred to as the “reference node”) and an ending node (referred to as the “non reference node”).

“Simple polygon” - An interior area of an outer boundary formed by a string of oriented links that begins and ends in one node. In one embodiment, a simple polygon does not cross itself.

“Polygon” - An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the database 127 follows certain conventions. For example, links do not cross themselves and do not cross each other except at a node or vertex. Also, there are no duplicated shape points, nodes, or links. Two links that connect each other have a common node or vertex. In the database 127, overlapping geographic features are represented by overlapping polygons. When polygons overlap, the boundary of one polygon crosses the boundary of the other polygon. In the database 127, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

In one embodiment, the database 127 is presented according to a hierarchical or multilevel tile projection. More specifically, in one embodiment, the database 127 may be defined according to a normalized Mercator projection. Other projections may be used. In one embodiment, a map tile grid of a Mercator or similar projection can a multilevel grid. Each cell or tile in a level of the map tile grid is divisible into the same number of tiles of that same level of grid. In other words, the initial level of the map tile grid (e.g., a level at the lowest zoom level) is divisible into four cells or rectangles. Each of those cells are in turn divisible into four cells, and so on until the highest zoom level of the projection is reached.

In one embodiment, the map tile grid may be numbered in a systematic fashion to define a tile identifier (tile ID). For example, the top left tile may be numbered 00, the top right tile may be numbered 01, the bottom left tile may be numbered 10, and the bottom right tile may be numbered 11. In one embodiment, each cell is divided into four rectangles and numbered by concatenating the parent tile ID and the new tile position. A variety of numbering schemes also is possible. Any number of levels with increasingly smaller geographic areas may represent the map tile grid. Any level (n) of the map tile grid has 2(n+1) cells. Accordingly, any tile of the level (n) has a geographic area of A/2(n+1) where A is the total geographic area of the world or the total area of the map tile grids. Because of the numbering system, the exact position of any tile in any level of the map tile grid or projection may be uniquely determined from the tile ID.

As shown, the database 127 includes node data records 201, road segment or link data records 203, POI data records 205, audio-based navigation records 207, other records 209, and indexes 211, for example. More, fewer or different data records can be provided. In one embodiment, additional data records (not shown) can include cartographic (“carto”) data records, routing data, and maneuver data. In one embodiment, the indexes 211 may improve the speed of data retrieval operations in the database 127. In one embodiment, the indexes 211 may be used to quickly locate data without having to search every row in the database 127 every time it is accessed.

In exemplary embodiments, the road segment data records 203 are links or segments representing roads, streets, or paths, as can be used in the calculated route or recorded route information for determination of one or more personalized routes. The node data records 201 are end points (such as intersections) corresponding to the respective links or segments of the road segment data records 203. The road link data records 203 and the node data records 201 represent a road network, such as used by vehicles, cars, and/or other entities. Alternatively, the database 127 can contain path segment and node data records or other data that represent pedestrian paths or areas in addition to or instead of the vehicle road record data, for example. In one embodiment, the road or path segments can include an altitude component to extend to paths or road into three-dimensional space (e.g., to cover changes in altitude and contours of different map features, and/or to cover paths traversing a three-dimensional airspace).

Links, segments, and nodes can be associated with attributes, such as geographic coordinates, a number of road objects (e.g., road markings, road signs, traffic light posts, etc.), types of road objects, traffic directions for one or more portions of the links, segments, and nodes, traffic history associated with the links, segments, and nodes, street names, address ranges, speed limits, turn restrictions at intersections, presence of roadworks, and other navigation related attributes, as well as POIs, such as gasoline stations, hotels, restaurants, museums, stadiums, offices, automobile dealerships, auto repair shops, factories, buildings, stores, parks, etc. The database 127 can include data about the POIs and their respective locations in the POI data records 205. The database 127 can also include data about places, such as cities, towns, or other communities, and other geographic features, such as bodies of water, mountain ranges, etc. Such place or feature data can be part of the POI data records 205 or can be associated with POIs or POI data records 205 (such as a data point used for displaying or representing a position of a city).

The audio-based navigation records 207 may include information associated with sound generators 113. Such information may indicate: (1) a location of a sound generator 113; (2) a type of sound generator 113; (3) types of sound that can be output by the sound generator 113; (4) one or more periods in which sound can be output at the sound generator 113; (5) one or more vehicles that is permitted to use the sound generator 113 for audio-based navigation; (6) position/orientation of one or more speakers of the sound generator 113; or (7) a combination thereof. The audio-based navigation record 207 may further store information associated with sound events acquired by one or more detection entities 115. For example, such information may indicate: (1) a location of a sound event; (2) a classification of the sound event; (3) one or more periods in which the sound event occurs; or (4) a combination thereof. The audio-based navigation records 207 may further store information on detection entities 115 that have acquired audio data in locations of sound events and/or locations including or proximate to sound generators 113. Such information may indicate: (1) a type of detection entity 113; (2) a number of audio recorders equipped by the detection entity 113; (3) a type of audio recorder equipped by the detection entity 113; (4) positions/orientations of audio recorders with respect to a body of the detection entity 113; (5) audio data recorded by the audio recorders of the detection entity 113; (6) vehicle movement data associated with the detection entity 113; (7) other attributes associated with the detection entity 113; or (8) a combination thereof. The audio-based navigation record 207 may also store a route of a vehicle (e.g., the vehicle 105), one or more locations of one or more sound generators 113 and/or one or more sound events with respect to the route, and a navigational instruction associated with each of said locations.

Other records 209 may include a map indicating one or more locations in which a non-audio-based navigation technique was rendered unreliable for a vehicle. Other records 209 may also store information associated to the map such as: (1) a type of non-audio-based navigation technique; (2) a threshold defining an instance in which the non-audio-based navigation technique is unreliable; (3) for a given location, a number of instances in which the non-audio-based navigation technique was unreliable; or (4) a combination thereof.

In one embodiment, the database 127 can be maintained by the services platform 117 and/or one or more of the content providers 121 in association with a map developer. The map developer can collect geographic data to generate and enhance the database 127. There can be different ways used by the map developer to collect data. These ways can include obtaining data from other sources, such as municipalities or respective geographic authorities. In addition, the map developer can employ field personnel to travel by vehicle along roads throughout the geographic region to observe attributes associated with one or more road segments and/or record information about them, for example. Also, remote sensing, such as aerial or satellite photography, can be used.

The database 127 can be a master database stored in a format that facilitates updating, maintenance, and development. For example, the master database or data in the master database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the vehicle 105, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received database in a delivery format to produce one or more compiled navigation databases.

The processes described herein for providing audio-based navigation may be advantageously implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof.

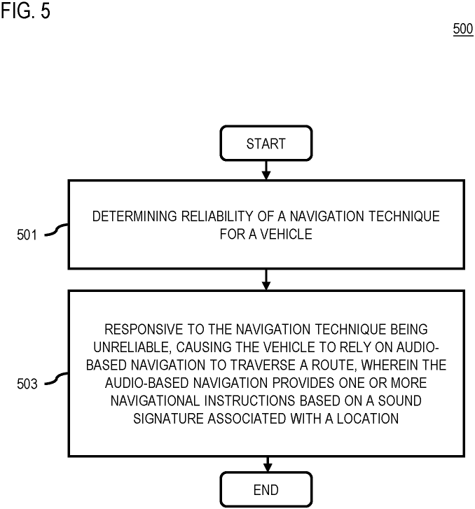

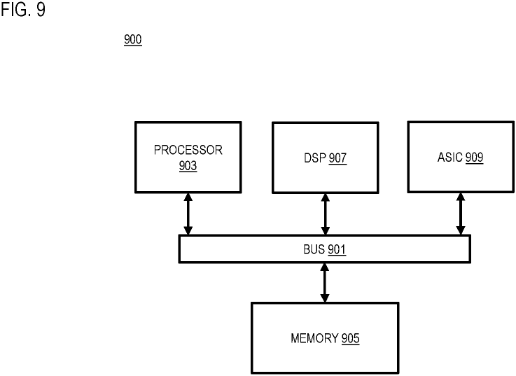

FIG. 5 is a flowchart of a process 500 for conditionally providing audio-based navigation, according to one embodiment. In one embodiment, the audio-based navigation platform 125 performs the process 500 and is implemented in, for instance, a chip set including a processor and a memory as shown in FIG. 9.

In step 501, the audio-based navigation platform 125 determines reliability of a navigation technique for a vehicle. In one embodiment, the navigation technique may be GPS. In such embodiment, reliability of the navigation technique may be quantified as CER.

In step 503, if the navigation technique is unreliable, the audio-based navigation platform 125 causes the vehicle to rely on audio-based navigation to traverse a route. The audio-based navigation provides one or more navigational instructions based on a sound signature associated with a location. In one embodiment, the navigation technique is deemed as being unreliable when the CER exceed a threshold (e.g., 100 meters). In one embodiment, the audio-based navigation platform 125 may identify a sound generator within the location and cause the sound generator to output the sound signature and provide the sound signature and a navigational instruction associated with the sound signature to the vehicle. As the vehicle traverses the location and captures the sound signature output by the sound generator via audio recorders of the vehicle, the vehicle generates a notification of the navigational instruction and/or maneuver the location based on the navigational instruction. In one embodiment, the audio-based navigation platform 125 may identify a sound event within the location provide sound signature associated with the sound event and a navigational instruction associated with the sound signature to the vehicle. As the vehicle traverses the location and captures the sound signature output by the sound event via audio recorders of the vehicle, the vehicle generates a notification of the navigational instruction and/or maneuver the location based on the navigational instruction.

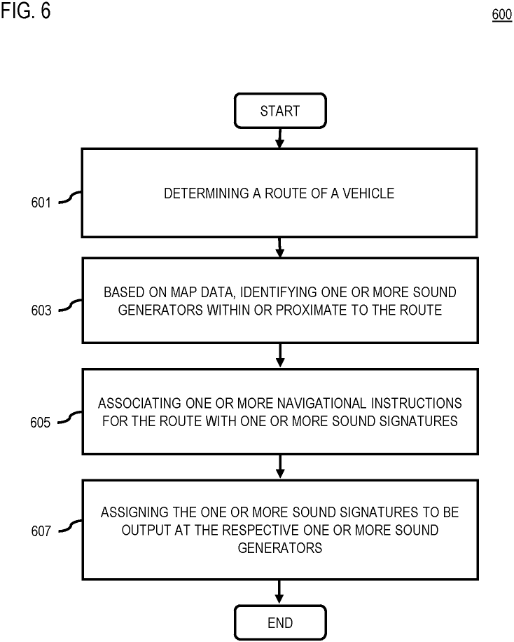

FIG. 6 is a flowchart of a process 600 for providing audio-based navigation based on one or more sound signatures output by one or more sound generators. In one embodiment, the audio-based navigation platform 125 performs the process 600 and is implemented in, for instance, a chip set including a processor and a memory as shown in FIG. 9.

In step 601, the audio-based navigation platform 125 determines a route of a vehicle. In one embodiment, the vehicle and/or a user interface associated with the vehicle and/or a user of the vehicle may provide the route of the vehicle to the audio-based navigation platform 125.

In step 603, the audio-based navigation platform 125 identifies one or more sound generators within or proximate to the route based on map data. The one or more sound generators may be stationary and be affixed at locations in which GPS is unreliable.

In step 605, the audio-based navigation platform 125 associates one or more navigational instructions for the route with one or more sound signatures. The audio-based navigation platform 125 may provide the one or more navigational instructions and the one or more sound signatures to the vehicle. As such, when the vehicle captures a sound signature via audio recorders of the vehicle, the vehicle may cause a notification of the corresponding navigation instruction on an interface and/or cause the vehicle to move based on the corresponding navigation instruction.

In step 607, the audio-based navigation platform 125 assigning the one or more sound signatures to be output at the respective one or more sound generators.

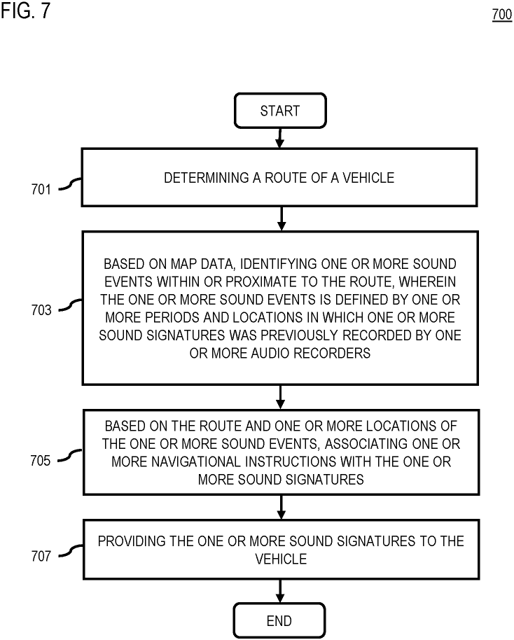

FIG. 7 is a flowchart of a process 700 for providing audio-based navigation based on one or more sound events. In one embodiment, the audio-based navigation platform 125 performs the process 700 and is implemented in, for instance, a chip set including a processor and a memory as shown in FIG. 9.

In step 701, the audio-based navigation platform 125 determines a route of a vehicle. In one embodiment, the vehicle and/or a user interface associated with the vehicle and/or a user of the vehicle may provide the route of the vehicle to the audio-based navigation platform 125.

In step 703, the audio-based navigation platform 125 identifies one or more sound events within or proximate to the route based on map data. The one or more sound events is defined by one or more periods and locations in which one or more sound signatures was previously recorded by one or more audio recorders. The one or more sound events may be defined within the map data. In one embodiment, a sound event may be added to the map data if a plurality of instances in which a sound signature associated with the sound event was recorded at the location of the sound event.

In step 705, the audio-based navigation platform 125 associates one or more navigational instructions with the one or more sound signatures based on the route and one or more locations of the one or more sound events. For example, if a portion of a route of a vehicle includes an intersection proximate to a sound event, the audio-based navigation platform 125: (1) identifies a direction at which the vehicle will be approaching the intersection by analyzing the route; (2) identifies a proximity of a sound event relative to the intersection; and (3) generates a navigational instruction based on the direction and a position at which the vehicle is estimated to capture a sound signature corresponding to the sound event. The one or more navigational instructions and the one or more sound signatures may be transmitted to the vehicle, thereby enabling the vehicle to identify the one or more sound signatures output by the one or more sound events and provide a response based on the one or more navigational instructions.

The system, apparatus, and methods described herein enable a map-based server/platform to a vehicle to rely on audio-based navigation when a conventional navigation technique, such as GPS, is rendered unreliable. As the system, apparatus, and methods described herein improves in-vehicle navigation and overall vehicle and road related safety.

The processes described herein may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

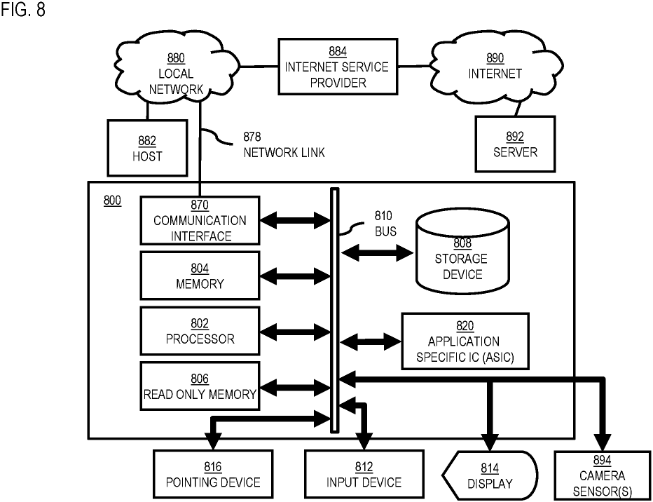

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide audio-based navigation as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, subatomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing audio-based navigation.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing audio-based navigation. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 800 also includes a memory 804 coupled to bus 810. The memory 804, such as a random access memory (RAM) or any other dynamic storage device, stores information including processor instructions for providing audio-based navigation. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing audio-based navigation, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 may be omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 123 for providing audio-based navigation to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 882 connected to the Internet hosts a process that provides a service in response to information received over the Internet. For example, server host 882 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 882 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide audio-based navigation as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing audio-based navigation.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real-time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors. The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide audio-based navigation. The memory 905 also stores the data associated with or generated by the execution of the inventive steps.

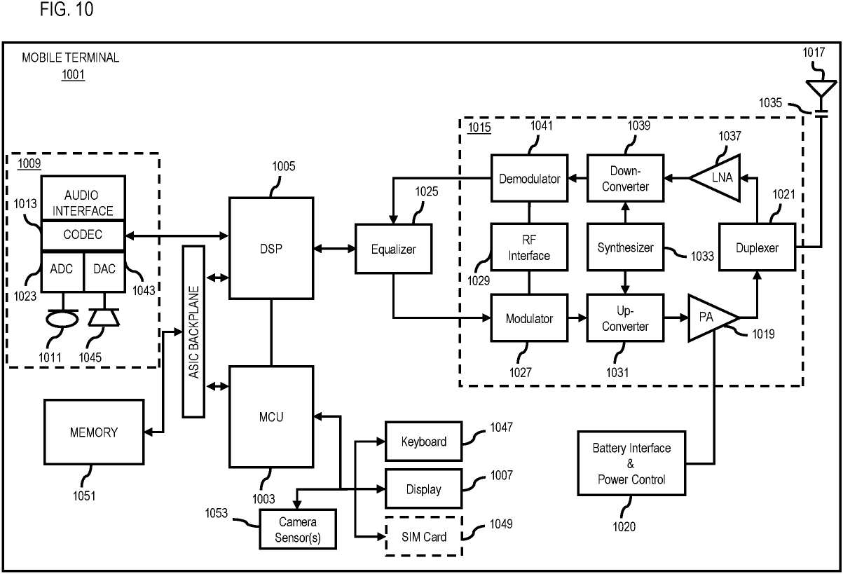

FIG. 10 is a diagram of exemplary components of a mobile terminal 1001 (e.g., a mobile device or vehicle or part thereof) for communications, which is capable of operating in the system of FIG. 1, according to one embodiment. In some embodiments, mobile terminal 1001, or a portion thereof, constitutes a means for performing one or more steps of providing audio-based navigation. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing audio-based navigation. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide audio-based navigation. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1010 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1149 also contains a memory for storing a personal telephone number registry, text messages, and user specific mobile terminal settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A non-transitory computer-readable storage medium having computer program code instructions stored therein, the computer program code instructions, when executed by at least one processor, cause the at least one processor to:
determine reliability of a navigation technique for a vehicle; and
responsive to the navigation technique being unreliable, cause the vehicle to rely on audio-based navigation to traverse a route, wherein the audio-based navigation provides one or more navigational instructions based on a sound signature associated with a location.

2. The non-transitory computer-readable storage medium of claim 1, wherein the navigation technique is a Global Positioning System (GPS) navigation.

3. The non-transitory computer-readable storage medium of claim 2, wherein the navigation technique is unreliable when a Circular Error Radius (CER) of the GPS navigation exceeds a non-zero threshold.

4. The non-transitory computer-readable storage medium of claim 3, wherein the threshold is at least 100 meters.

5. The non-transitory computer-readable storage medium of claim 1, wherein the sound signature indicates attributes of sound previously recorded within the location.

6. The non-transitory computer-readable storage medium of claim 5, wherein one or more audio recorders has previously recorded the sound within the location, and wherein a remote server stores the sound signature.

7. The non-transitory computer-readable storage medium of claim 6, wherein the sound signature is provided to the vehicle by the remote server.

8. The non-transitory computer-readable storage medium of claim 7, wherein a speaker disposed at the location is instructed by the remote server to generate the sound.

9. The non-transitory computer-readable storage medium of claim 1, wherein the computer program code instructions, when executed by the at least one processor, cause the at least one processor to: (i) cause a user interface associated with the vehicle to display the one or more navigational instructions; (ii) cause the vehicle to move based on the one or more navigational instructions; or (iii) a combination thereof.

10. An apparatus comprising at least one processor and at least one non-transitory memory including computer program code instructions, the computer program code instructions configured to, when executed, cause the apparatus to:
determine a route of a vehicle;
based on map data, identify one or more speakers within or proximate to the route;
associate one or more navigational instructions for the route with one or more sound signatures; and
assign the one or more sound signatures to be output at the respective one or more speakers.

11. The apparatus of claim 10, wherein the one or more sound signatures is outside a human hearing frequency range.

12. The apparatus of claim 10, wherein the computer program code instructions are configured to, when executed, cause the apparatus to:
determine reliability of a navigation technique for the vehicle; and
responsive to the navigation technique being unreliable, provide the one or more sound signatures and the one or more navigational instructions to the vehicle.

13. The apparatus of claim 12, wherein the navigation technique is a Global Positioning System (GPS) navigation.

14. The apparatus of claim 13, wherein the navigation technique is unreliable when a Circular Error Radius (CER) of the GPS navigation exceeds a non-zero threshold.

15. The apparatus of claim 14, wherein the threshold is at least 100 meters.

16. The apparatus of claim 10, wherein the one or more speakers is stationary.

17. A method of providing audio-based navigation, the method comprising:
determining reliability of a navigation technique for a vehicle; and
responsive to the navigation technique being unreliable:
determining a route of a vehicle;
based on map data, identifying one or more sound events within or proximate to the route, wherein the one or more sound events is defined by one or more periods and locations in which one or more sound signatures was previously recorded by one or more audio recorders;
based on the route and one or more locations of the one or more sound events, associating one or more navigational instructions with the one or more sound signatures; and
providing the one or more sound signatures to the vehicle.

18. The method of claim 17, wherein the navigation technique is a Global Positioning System (GPS) navigation.

19. The method of claim 18, wherein the navigation technique is unreliable when a Circular Error Radius (CER) of the GPS navigation exceeds a non-zero threshold.

20. The method of claim 19, wherein the threshold is at least 100 meters.
